(19) United States
(12) Patent Application Publication
(10) Pub. No.: US 2025/0189867 A1
(43) Pub. Date: Jun. 12, 2025

(54) ACTUATOR FOR CAMERA

(71) Applicant: JAHWA electronics Co., Ltd., Chungcheongbuk-do (KR)

(72) Inventors: JAE YONG GO, Chungcheongbuk-do (KR); CHUL SOON PARK, Chungcheongbuk-do (KR)

(21) Appl. No.: 18/906,379

(22) Filed: Oct. 4, 2024

(30) Foreign Application Priority Data
Dec. 6, 2023 (KR) 10-2023-0175168

(51) Int. Cl. G03B 5/02; G03B 17/12

(52) U.S. Cl. CPC G03B 5/02; G03B 17/12

(57) ABSTRACT

An actuator for a camera includes a reflector configured to reflect light of a subject to an image sensor installed in an inclined form and including a reflection surface with an inclination angle different from a slope of the image sensor, a carrier on which the reflector is installed, a driving unit configured to move the carrier forward and backward in the direction of the image sensor; a housing configured to support the movement of the carrier, a guiding rail provided to at least one of the housing and the carrier, and a ball disposed on the guiding rail.

### CROSS-REFERENCE TO RELATED APPLICATION AND CLAIM OF PRIORITY

This application claims the benefit under 35 USC § 119 of Korean Patent Application No. 10-2023-0175168 filed on Dec. 6, 2023 in the Korean Intellectual Property Office (KIPO), the entire disclosures of which are incorporated by reference herein.

### BACKGROUND

### 1. Technical Field

The present disclosure relates to an actuator for a camera, and more specifically, to an actuator for a camera with further improved driving precision by improving the structure that physically supports the movement of a carrier.

### 2. Background Art

Advances in hardware technology for image processing and growing consumer need for making and taking photos and videos have driven implementation of such functions as autofocusing (AF) and optical image stabilization (OIS) in stand-alone cameras as well as camera modules mounted on mobile terminals including cellular phones and smartphones.

An autofocus (AF) function (or, an automatically focusing function) means a function of a focal length to a subject by linearly moving a carrier having a lens in an optical axis direction to generate a clear image at an image sensor (CMOS, CCD, etc.) located at the rear of the lens.

One typical method for implementing the AF or OIS function is to install a magnet (a coil) on a mover (a carrier) and install a coil (a magnet) on a stator (a housing, or another type of carrier, or the like), and then generate an electromagnetic force between the coil and the magnet so that the mover moves in the optical axis direction or in a direction perpendicular to the optical axis.

Recently, in order to increase space utilization, an actuator with a structure that refracts the light of a subject passing through a lens toward an image sensor using a reflector has been disclosed. This actuator is configured so that the focal distance or the like is adjusted by moving a carrier on which the reflector is mounted forward and backward in the direction of the image sensor.

The image sensor is usually fixed to stand up on a main board of an application device such as a smartphone. Therefore, when the carrier on which the reflector is installed for AF or the like moves closer to or farther away from the image sensor, the light of the subject shifts upward or downward based on the reference position due to the change in the position of the carrier.

If the light reflected from the reflector and incident on the image sensor is shifted in this way, the image data of the subject may also be shifted accordingly.

Conventionally, algorithms for post-processing image data have been mainly applied to solve this problem. However, since this method accurately calculates the dynamically changing movement amount of the carrier and applies an appropriate correction algorithm accordingly, processing speed may be lowered, and image data in the edge area must be inevitably removed to improve image deviation. Therefore, it is impossible to provide images that exactly match the intended photographing area.

### SUMMARY

The present disclosure is designed to solve the problems of the related art, and therefore the present disclosure is directed to providing an actuator for a camera that may always keep the light of a subject at the same position regardless of the position of a carrier by improving a structure that guides the physical movement of the carrier so that the posture of the carrier may naturally change depending on the moving position of the carrier where the reflector is installed.

These and other objects and advantages of the present disclosure may be understood from the following detailed description and will become more fully apparent from the exemplary embodiments of the present disclosure. Also, it will be easily understood that the objects and advantages of the present disclosure may be realized by the means shown in the appended claims and combinations thereof.

In one aspect of the present disclosure, there is provided an actuator for a camera, including: a reflector configured to reflect light of a subject to an image sensor installed in an inclined form and including a reflection surface with an inclination angle different from a slope of the image sensor; a carrier on which the reflector is installed; a driving unit configured to move the carrier forward and backward in the direction of the image sensor; a housing configured to support the movement of the carrier; a guiding rail provided to at least one of the housing and the carrier; and a ball disposed on the guiding rail.

Preferably, the guiding rail of the present disclosure may include an inclined portion that tilts a posture of the carrier when the carrier moves.

In addition, the reflector is preferably installed on the carrier so that when an angle of the image sensor relative to a horizontal plane is A°, an angle of the reflection surface is 0.5A° relative to the horizontal plane.

Specifically, the guiding rail of the present disclosure may include a first guiding rail having a shape extending in a direction in which the carrier moves; and a second guiding rail having a shape extending in the direction in which the carrier moves and located closer to the image sensor than the first guiding rail.

In addition, the first guiding rail of the present disclosure preferably has a shape that becomes lowered in a direction toward the image sensor.

Moreover, the second guiding rail of the present disclosure preferably has a shape that becomes raised in a direction toward the image sensor.

Depending on the embodiment, the actuator for a camera according to an embodiment of the present disclosure may further include an OIS carrier on which a lens is mounted, the OIS carrier being configured to move in two directions orthogonal to each other based on a horizontal plane and being accommodated in the carrier, and the reflector may be configured to reflect the light of the subject passing through the lens to the image sensor.

According to a preferred embodiment of the present disclosure, since a structure that refracts the light path of the subject passing through the lens using a reflector is applied, it is possible to further improve the spatial usability of the actuator.

According to the present disclosure, since the posture of the carrier according to the moving position of the reflector, namely the angle at which light passing through the lens is incident on the image sensor, may be dynamically changed just with a simple structural improvement, it is possible to fundamentally resolve the problem that the light of the subject flowing into the image sensor is shifted without applying a complex post-processing algorithm.

According to the present disclosure, since the light path by the reflector is changed through the physical structure, the clarity of the operational relationship may be maintained at all times, and no post-processing is required, so it is possible to further improve the precision and immediacy of AF operation.

### BRIEF DESCRIPTION OF THE DRAWINGS

The accompanying drawings illustrate a preferred embodiment of the present disclosure and together with the foregoing disclosure, serve to provide further understanding of the technical spirit of the present disclosure, and thus, the present disclosure is not construed as being limited to the drawing.

FIG. 1 is a drawing showing the overall configuration of an actuator for a camera according to a preferred embodiment of the present disclosure,

FIG. 2 is a drawing showing a carrier and its related detailed configuration according to an embodiment of the present disclosure,

FIG. 3 is a diagram for illustrating a structure that reflects the light of a subject toward an image sensor,

FIGS. 4 and 5 are drawings for illustrating a guiding rail or the like according to the present disclosure,

FIG. 6 is a diagram for illustrating an optical path according to the posture change of the carrier,

FIGS. 7A and 7B are drawings showing the first and second guiding rail according to another embodiment of the present disclosure,

FIGS. 8 and 9 are diagrams showing the detailed configuration of the present disclosure that implements OIS.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

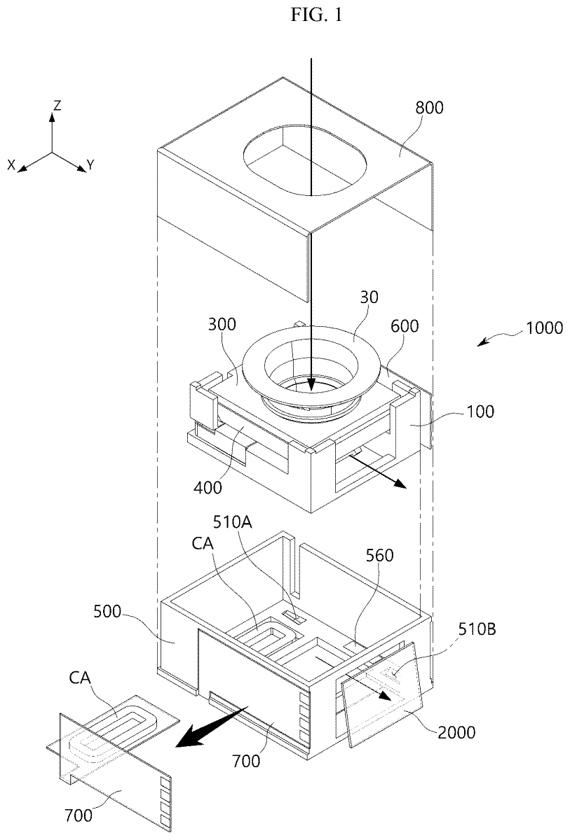

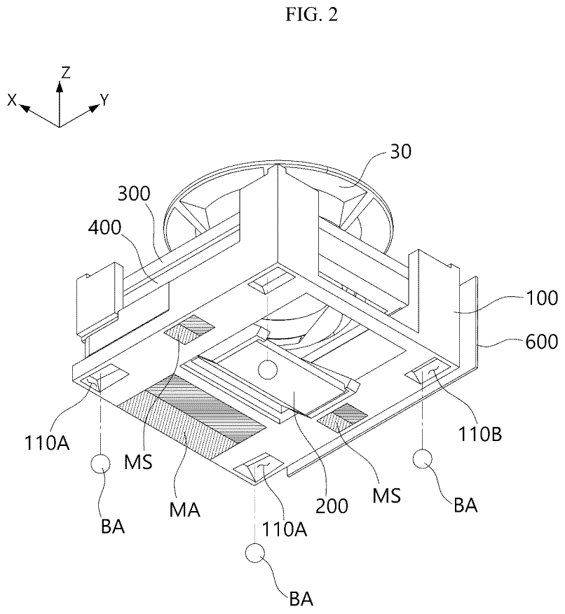

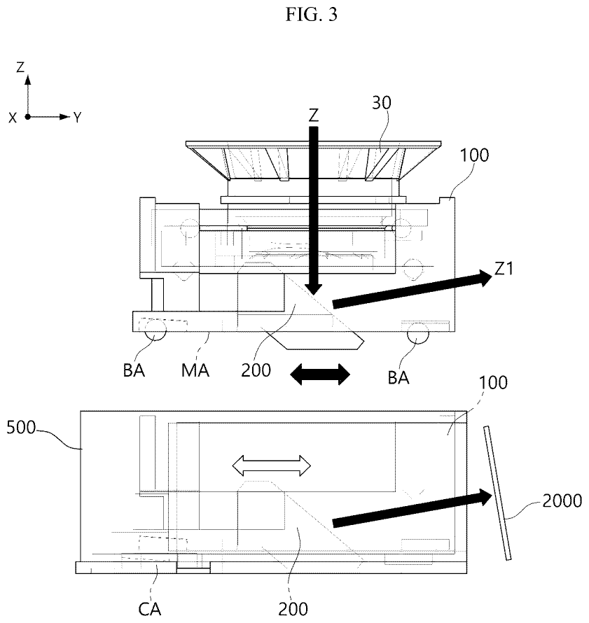

FIG. 1 is a drawing showing the overall configuration of an actuator for a camera (hereinafter, referred to as an ‘actuator’) 1000 according to a preferred embodiment of the present disclosure, FIG. 2 is a drawing showing a carrier 100 and its related detailed configuration according to an embodiment of the present disclosure, and FIG. 3 is a diagram for illustrating a structure that reflects the light of a subject toward an image sensor 2000.

Hereinafter, the overall structure of the present disclosure and an embodiment of the present disclosure to implement AF will be described first, and an embodiment of the present disclosure to implement OIS will be provided later.

The actuator 1000 of the present disclosure illustrated in FIG. 1 is an embodiment in which AF and OIS are implemented together, but of course, the actuator 1000 of the present disclosure may be implemented as an actuator only for AF depending on the embodiment.

As shown in the drawing, the actuator 1000 of the present disclosure may include a carrier 100, a reflector 200, a lens carrier 300, a middle guide 400, a housing 500, and a case 800.

The housing 500, which provides an inner space, is a configuration corresponding to the basic frame structure of the actuator 1000 according to the present disclosure, and may be not only configured in an integrated form, but may also be divided into multiple parts and then assembled as needed to increase the efficiency of the assembly process. Depending on the embodiment, the case 800, which functions as a shield can, may be coupled to the housing 500.

The lens carrier 300 or/and the middle guide 400 of the present disclosure is a configuration to implement OIS and corresponds to a moving object moving in a direction perpendicular to the optical axis direction (one or more of the X-axis direction and Y-axis direction). This will be described later in detail.

The axes shown in the drawings, terms referring to the axes, and terms such as top, bottom, front, rear, vertical, horizontal, etc. described with respect to the axes are intended to present relative standards for describing embodiments of the present disclosure, and, it is self-evident that these terms are not intended to specify any direction or location on an absolute basis, and of course, these terms may vary relatively depending on the location of a target object, the location of an observer, a viewing direction, etc.

Hereinafter, in describing the present disclosure, the direction axis corresponding to the path through which the light of a subject flows into the lens 30, namely the direction axis corresponding to the vertical longitudinal direction of the lens, is defined as an optical axis (Z-axis), and two axes on the plane (horizontal plane) perpendicular to this optical axis (Z-axis) are defined as X-axis and Y-axis.

The carrier 100 of the present disclosure is as a relative fixed body and is configured to move the housing 500 forward and backward in the direction of the image sensor 2000. As shown in the drawings, the reflector 200 that reflects or refracts the light of the subject is mounted at the center portion of the carrier 100.

As illustrated in FIG. 3, the light of the subject incident in the optical axis (Z-axis) direction is refracted in the direction of the image sensor 2000 by the reflector 200 mounted on the carrier 100 and flows into the image sensor 2000. The direction indicated by Z1 in FIG. 3 is the path direction of light reflected by the reflector 200 and incident on the image sensor 2000.

For efficiency of explanation, the Z-axis shown in FIG. 3, namely the direction axis of the light in which the light of the subject is incident to the reflector 200, is defined as a first optical axis, and the Z1 axis shown in FIG. 3, namely the direction axis of the light reflected by the reflector 200 incident to the image sensor 2000, is defined as a second optical axis.

It is preferable that the image sensor 2000 is installed in an inclined form with a predetermined angle as shown in FIG. 3 rather than being installed perpendicular to the horizontal plane.

In this configuration, even when the reflector 200 moves toward or away from the image sensor 2000, the optical center may be maintained more effectively, and it is possible to suppress the phenomenon that the light of the subject is shifted by the reflector 200.

If the carrier 100 of the present disclosure moves in a direction toward or away from the image sensor 2000 (Y-axis direction based on the drawing), the reflector 200 moves along with the carrier 100 since it is fixedly installed to the carrier 100. In this way, when the reflector 200 moves, the length of the light path along which the light of the subject enters the image sensor 2000 changes, thereby implementing AF.

The driving unit of the present disclosure is a component that moves the carrier 100, and the driving unit may be implemented in various applications such as shape memory alloy (SMA), piezoelectric devices, micro electro mechanical systems (MEMS), and the like as long as the carrier 100 can be moved in a specific direction using an external control signal or a detected signal system.

However, considering efficiency such as device miniaturization, power consumption, noise suppression, space utilization, linear movement characteristics, and precise control, it is desirable that the driving unit is implemented in a configuration that applies the electromagnetic force generated between a magnet and a coil.

Specifically, the driving unit according to a preferred embodiment of the present disclosure may include an AF magnet MA provided in any one of the carrier 100, which is a mobile body, and the housing 500, which is a relatively fixed body, and an AF coil CA provided in the other one of the carrier 100 and the housing 500 to which the AF magnet MA is not provided.

In order to more simply implement the electrical wiring relationship and physical coupling structure, it is preferable that the AF magnet MA is installed in the carrier 100, which is a moving body, and the AF coil CA is installed in the housing 500, which is a relative fixed body.

As illustrated in the drawings, the AF coil CA may be bent or have a three-dimensional shape to enable effective interfacing with external modules, power supplies, and external devices, and it is desirable that the AF coil CA is mounted to the first circuit board 700 that is fully or partially exposed to the outside.

When power of appropriate magnitude and direction is applied to the AF coil CA under the control of an operation driver (not shown) or the like, magnetic force (electromagnetic force) is generated between the AF coil CA and the AF magnet MA installed on the carrier 100, and this generated magnetic force allows the carrier 100 to move forward and backward in the direction of the image sensor 2000 with the housing 500 as a relative fixed body.

Depending on the embodiment, a detection sensor may be further included as a component for such movement control. In this case, when the detection sensor detects the position of the carrier 100 (specifically, the AF magnet MA or the sensing magnet installed on the carrier 100, etc.) and transmits the corresponding signal to the operation driver, the operation driver performs feedback control so that power of the corresponding magnitude and direction is applied to the AF coil CA.

The detection sensor may be implemented as a hall sensor that detects the change in magnitude and direction of the magnetic field of a magnet present in the detection area using the Hall effect and outputs an electrical signal accordingly.

If the actuator 1000 according to the present disclosure is an actuator that implements only the AF function, the lens carrier 300 shown in the drawings may be fixedly coupled to the carrier 100, and of course, depending on the embodiment, the lens 30 may be directly mounted on the carrier 100.

At least one of the housing 500 and the carrier 100 may include guiding rails 510A, 510B, 110A, 110B, and at least one AF ball BA may be disposed on the guiding rails 510A, 510B, 110A, 110B.

In order to more clearly implement the direction of movement, it is desirable to configure the AF ball BA so that it is partially accommodated in the guiding rails 510A, 510B, 110A, 110B.

If the AF ball BA is interposed as above, the mover (carrier 100) may move more flexibly due to the minimized friction caused by the ball's rolling, moving, rotation, and point-contact with the facing object, and also there is an advantage of reducing noise and minimizing driving force, as well as improving driving precision.

Depending on the embodiment, the housing 500 of the present disclosure may include a sub yoke 560 made of a magnetic material that generates attractive force to the sub magnet MS provided in the carrier 100.

In this configuration, the carrier 100 is brought into close contact toward the housing 500 (Z-axis direction based on the drawing) with the AF ball BA interposed therebetween due to the attraction or suction force between the sub magnet MS and the sub yoke 560, so that the physical contact not only between the AF ball BA and the carrier 100 but also between the AF ball BA and the housing 500 may continue.

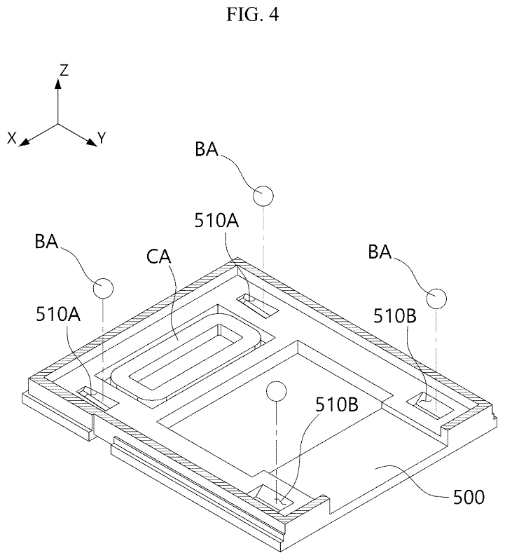

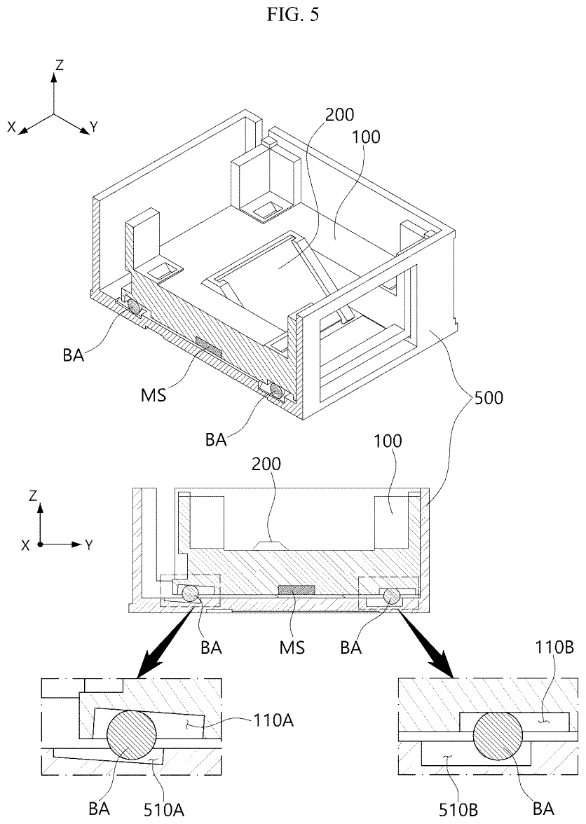

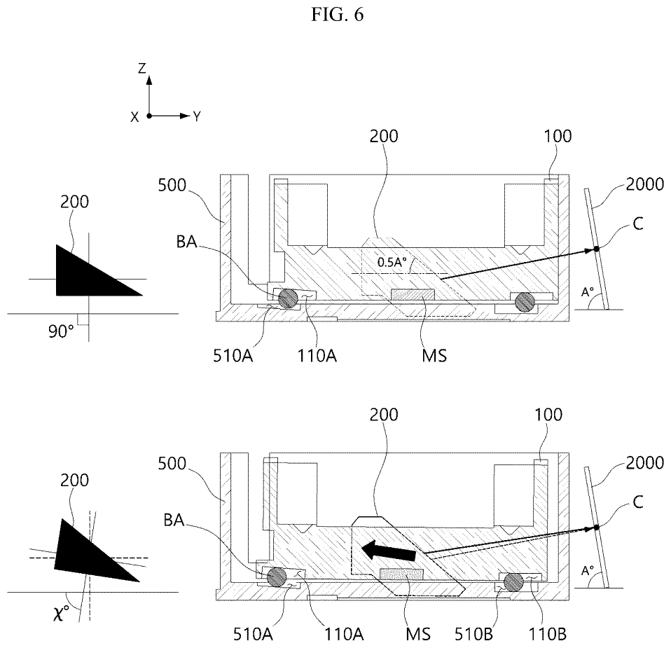

FIGS. 4 and 5 are drawings for illustrating a guiding rail or the like according to the present disclosure, and FIG. 6 is a diagram for illustrating an optical path according to the posture change of the carrier. Hereinafter, an embodiment of the present disclosure in which the posture of the reflector 200 changes in relation to AF operation will be described in detail with reference to FIGS. 4 to 6.

As explained previously, the guiding rail of the present disclosure may be provided to at least one of the housing 500 and the carrier 100.

If the guiding rail is provided to only one of the housing 500 and the carrier 100, the other of the housing 500 and the carrier 100 may include at least one pockets that accommodate the AF ball BA and prevent the AF ball BA from being separated to the outside.

In the following description, the technical content of the present disclosure will be explained based on an embodiment in which the guiding rail is provided to both the housing 500 and the carrier 100.

In the following description, depending on the location where the guiding rail is provided, the guiding rail provided in the housing 500 is designated using reference sign 510 (510A, 510B), and the guiding rail provided in the carrier 100 is designated using reference sign 110 (110A, 110B).

In addition, the guiding rail of the present disclosure may include a first guiding rail 510A, 110A located relatively far away from the image sensor 2000 and a second guiding rail 510B, 110B located closely, as illustrated in the drawings for stable support or guidance of the carrier 100.

At least one of the guiding rails 510A, 110A, 510B, 110B may be provided in plurality as illustrated in the drawings, and all or some of the guiding rails 510A, 110A, 510B, 110B are preferably configured to have a groove or a structure corresponding thereto with a shape extending in the direction along which the carrier 100 moves (Y-axis direction).

The first guiding rails 510A, 110A according to an embodiment of the present disclosure are configured to include a shape whose height is lowered toward the image sensor 2000, as illustrated in the drawings.

In other words, the first guiding rails 510A, 110A may be configured to include a part with a shape that has a low height near the image sensor 2000 and a high height near the image sensor 2000. The shape with such a change in height may be implemented as a straight line or a slope such as a curve.

As shown in FIG. 6, according to an embodiment in which the first guiding rails 510A, 110A have a shape whose height decreases in the direction of the image sensor 2000 (hereinafter referred to as ‘first inclination shape’), when the carrier 100 moves in a direction approaching the image sensor 2000 (+Y-axis direction based on the drawing), the rear of the carrier 100 is relatively lowered.

On the contrary, when the carrier 100 moves in a direction away from the image sensor 2000 (−Y-axis direction based on the drawing), the rear of the carrier 100 is relatively raised.

Depending on the embodiment, when the carrier 100 is located at a default position, which may be determined as the center of the AF driving area or the like, it is desirable to design the angle or position of the first inclination shape so that the carrier 100 is horizontal.

The first inclination shape may be implemented in the entire first guiding rail 510A, 110A, or in a part of the first guiding rail 510A, 110A. In addition, the inclination angle or radius of curvature of the first inclination shape may be set by considering the optical characteristics of the reflector 200, the characteristics of the image sensor 2000, the separation distance between the reflector 200 and the image sensor 2000, and the total driving distance for AF.

If the posture of the carrier 100 is tilted according to the direction and degree of movement of the carrier 100 as above, the reflector 200 installed on the carrier 100 may also be induced to tilt at the same angle.

Specifically, if the reflector 200 moves in a direction away from the image sensor 2000, the angle at which the reflection surface of the reflector 200 faces the image sensor 2000 (hereinafter referred to as ‘reflection angle’) is inclined downward by an angle that has a functional relationship with the moving-away distance, and due to this change in reflection angle, the light incident from the reflector 200 to the image sensor 2000 moves downward.

If the reflector moves backwards along the straight line (linearly) corresponding to the horizontal plane without such tilt or angle change, the point at which the light of the subject enters the reflector rises (Z-axis direction) due to the parallel movement, so that the light reflected by the reflector and incident on the image sensor is also shifted to the upper direction (Z-axis direction).

However, according to the embodiment of the present disclosure, if the reflector 200 moves in a direction away from the image sensor 2000, the reflection angle of the reflector 200 is tilted downward corresponding to the distance by which the reflector 200 has moved, so it is possible to essentially solve the conventional problem that the light of the subject is shifted.

From a corresponding perspective, if the carrier 100 moves in a direction approaching the image sensor 2000, the reflection angle of the reflector 200 increases upward corresponding to the distance by which the reflector 200 has moved, so the light incident on the image sensor 2000 also moves upward.

Meanwhile, if the reference angle of the horizontal plane of the image sensor 2000 installed in the application device or the like so that the light of the subject may flow into the image sensor 2000 in the vertical direction is A°, it is desirable to install the reflector 200 at the carrier 100 so that the angle of the reflection surface of the reflector 200 becomes 0.5A° relative to the horizontal plane.

As illustrated in FIGS. 3 and 6, the reflection surface of the reflector 200 is aligned at a different angle from the image sensor 2000, specifically the incident surface of the image sensor 2000, based on the second optical axis Z1 or the like.

As described above, if the reflector 200 moves closer to the image sensor 2000 or moves away from the image sensor 2000 due to the physical movement of the carrier 100, the angular misalignment between the reflection surface of the reflector 200 and the incident surface of the image sensor 2000 becomes larger or smaller.

Since the angular misalignment changes depending on the moving direction and moving distance of the reflector 200 as above, even if the reflector 200 moves, the light of the subject reflected from the reflector 200 is always incident on the fixed position of the image sensor 2000, so it is possible to fundamentally resolve the phenomenon that the light of the subject is shifted.

In addition, the reflector 200 of the present disclosure may be one of a mirror or a prism, or a combination thereof, and may be implemented using various members that may change the optical path of a subject introduced from outer space toward the image sensor 2000. Of course, depending on the embodiment, the reflector 200 may be implemented in a type of assembly form along with a frame that physically supports a mirror or the like.

In the former embodiment, both the first guiding rail 510A provided in the housing 500 and the first guiding rail 110A provided in the carrier 100 have the first inclination shape. However, the technical idea of the present disclosure described above may also be implemented even when any one of the first guiding rail 510A provided in the housing 500 and the first guiding rail 110A provided in the carrier 100 have the first inclination shape and the other has a straight shape or pocket shape.

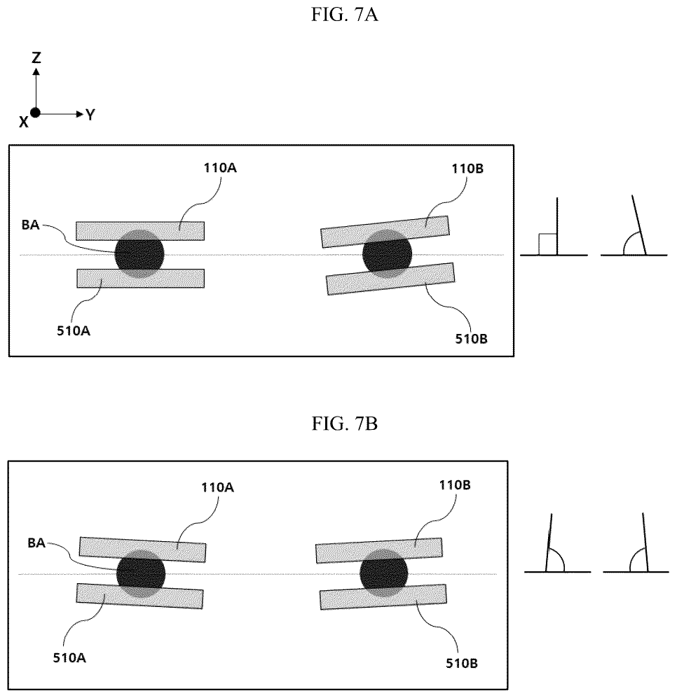

FIGS. 7A and 7B are drawings showing the first guiding rail 510A, 110A and the second guiding rail 510B, 110B according to another embodiment of the present disclosure,

As described above, in the actuator 1000 according to the present disclosure, when the carrier 100 moves close to or away from the image sensor 2000, the posture of the carrier 100, specifically the reflector 200 installed on the carrier 100, may be tilted by a corresponding amount so that the reflection angle at which the reflection surface of the reflector 200 faces the image sensor 2000 may change dynamically and naturally.

The former embodiment corresponds to an embodiment in which the posture of the reflector 200 is tilted by including an inclined part in the first guiding rails 510A, 110A.

The technical idea of the present disclosure described above may also be implemented by the second guiding rails 510B, 110B provided at positions close to the image sensor 2000 among the guiding rails, as illustrated in FIGS. 7A and 7B.

To this end, the second guiding rails 510B, 110B may have a shape whose height increases toward the image sensor 2000 (hereinafter referred to as a ‘second inclination shape’), as illustrated in FIG. 7A.

If the second guiding rail 510B, 110B includes the second inclination shape as above, when the carrier 100 moves in the direction approaching the image sensor 2000 (+Y-axis direction based on the drawing), the front of the carrier 100 becomes relatively raised and the rear becomes relatively lowered.

Meanwhile, if the carrier 100 moves away from the image sensor 2000 (−Y-axis direction based on the drawing), the front of the carrier 100 becomes relatively lowered and the rear of the carrier 100 becomes relatively raised.

Therefore, as in the embodiment of the present disclosure described above, it is possible to induce the tilt of the reflector 200 that changes functionally depending on the movement direction and degree of the carrier 100.

Depending on the embodiment, as shown in FIG. 7B, the second guiding rails 510B, 110B provided at close positions relative to the image sensor 2000 may be configured to include the second inclination shape, and the first guiding rails 510A, 110A provided at relatively distant positions may be configured to include the first inclination shape.

In this configuration, since the angle tilt is complexly formed in the front and rear with respect to the image sensor 2000, the inclinations of the guiding rails 510A, 510B, 110A, 110B may be relatively smaller compared to the former embodiment, so it is possible to lower the height (Z-axis direction) of the actuator 1000, thereby increasing the space utilization of the actuator 1000.

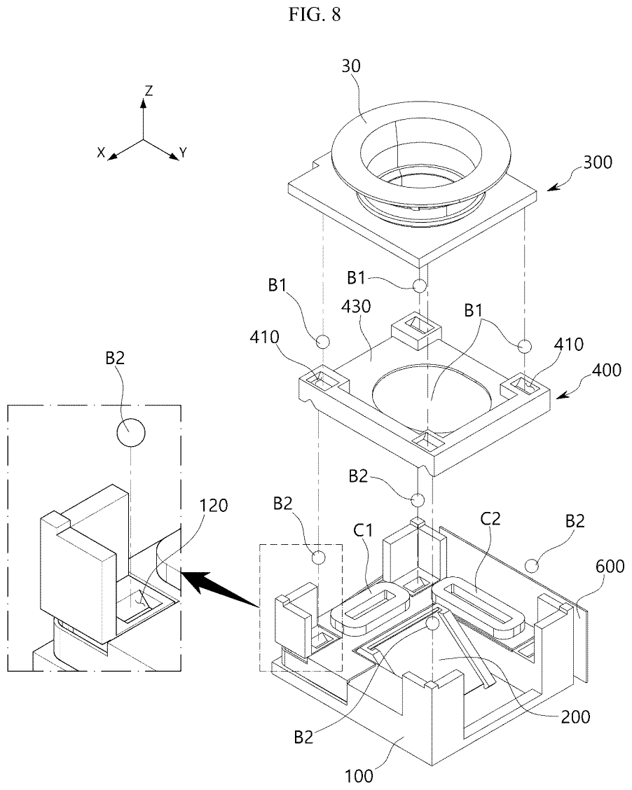

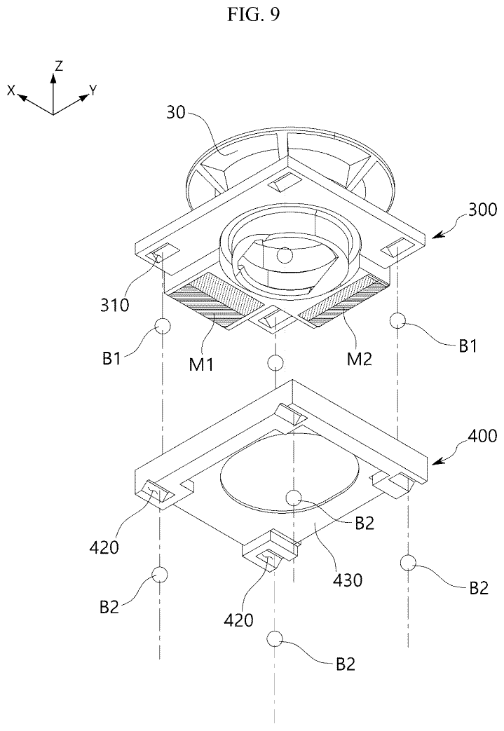

FIGS. 8 and 9 are diagrams showing the detailed configuration of the present disclosure that implements OIS.

The OIS carrier of the present disclosure, on which the lens 30 is mounted, is accommodated in the carrier 100 and is configured to move in two directions orthogonal to each other based on the horizontal plane (XY plane). Depending on the embodiment, the OIS carrier may include a lens carrier 300 and a middle guide 400.

The lens carrier 300 on which the lens 30 is mounted corresponds to a moving object that moves in a first direction (Y-axis direction) and a second direction (X-axis direction) perpendicular to the optical axis (Z-axis). A first magnet M1 facing the first coil C1 and a second magnet M2 facing the second coil C2 are installed at the lens carrier 300.

The first OIS ball B1 may be disposed between the lens carrier 300 and the middle guide 400. Specifically, the first OIS ball B1 may be disposed between the first rail 310 provided in the lens carrier 300 and the first rail 410 provided in the middle guide 400.

The drawing shows an embodiment in which the first rails 310, 410 are provided in both the lens carrier 300 and the middle guide 400, but depending on the embodiment, the first rail may be provided to only one of the lens carrier 300 and the middle guide 400.

As shown in the drawings, since the first rails 310, 410 have a groove extending in the first direction (Y-axis direction), when a driving force occurs between the first coil C1 and the first magnet M1, the lens carrier 300 moves in the first direction through the physical guidance of the first OIS ball B1 and the first rail 310, 410, and through this movement, hand tremor in the first direction component is corrected.

The second OIS ball B2 may be disposed between the second rail 420 provided in the middle guide 400 and the second rail 120 provided in the carrier 100. The second rails 420, 120 have a shape extending in the second direction (X-axis direction), which is perpendicular to the first direction (Y-axis direction).

If a current of appropriate magnitude and direction is supplied to the second coil C2, magnetic force (electromagnetic force) is generated between the second coil C2 and the second magnet M2, and by using this generated magnetic force as a driving force, the lens carrier 300 moves in the second direction through physical guiding of the second OIS ball B2 and the second rail 420, 120, and through this movement, hand tremor in the second direction component is corrected.

The first rail 310, 410 and the second rail 420, 120 have a shape extending in directions orthogonal to each other. Also, since the first OIS ball B1 and the second OIS ball B2 are accommodated between the first rail 310, 410 and the second rail 420, 120, respectively, movement in one direction is guided, but movement in other directions is suppressed.

Therefore, when a driving force occurs between the first coil C1 and the first magnet M1, the lens carrier 300 moves in the Y-axis direction through the guidance of the first rail 310, 410 and the first OIS ball B1, but the middle guide 400 does not move.

Meanwhile, when a driving force (in the second direction) occurs between the second coil C2 and the second magnet M2, the movement of the lens carrier 300 with the middle guide 400 as a relative fixed body is suppressed by the first rail 310, 410 and the first OIS ball B1.

Therefore, when a driving force occurs between the second coil C2 and the second magnet M2, the lens carrier 300 moves in the second direction through the physical guidance of the second rails 420, 120 and the second OIS ball B2 along with the middle guide 400.

The middle guide 400 of the present disclosure, which is disposed between the carrier 100 and the lens carrier 300, includes a second rail 420 on an upper surface thereof and a first rail 410 on a lower surface thereof, and thus the middle guide 400 functions as a relatively fixed body for movement in the Y-axis direction of the lens 30 and functions as a moving body in relationship with the carrier 100 or the housing 500, which is a relative fixed body, for movement in the X-axis direction of the lens 30. The middle guide 400 may include an insert 430 to enhance durability or the like, depending on the embodiment.

The drawings show an example in which the first and second coils C1, C2 are installed on the carrier 100, and the first and second magnets M1, M2 are installed at the lower part of the lens carrier 300.

However, depending on the embodiment, the first and second magnets M1, M2 may be installed on the side of the lens carrier 300, and the first and second coils C1, C2 may be installed on the side of the housing 500. In addition, of course, it is also possible that one of the first and second magnets M1, M2 is installed on the lens carrier 300, and the other is installed on the middle guide 400.

If the actuator 1000 of the present disclosure includes an OIS carrier as above, the reflector 200 described above is configured to reflect the light of the subject passing through the lens 30 mounted on the lens carrier 300 toward the image sensor 2000.

The first and second coils C1, C2 may be implemented to be mounted on the second circuit board 600, which is partially exposed to the outside, in the same way as the first circuit board 700 described above.

The drawing shows an embodiment in which the lens carrier 300 and the middle guide 400 move in the X-axis direction and Y-axis direction. However, it is also possible that the lens carrier 300 and the middle guide 400 are designed to move based on two directions orthogonal to each other, which are different from the X-axis direction and Y-axis direction illustrated in the drawings, based on the horizontal plane.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

In the above description of this specification, the terms such as “first” and “second” etc. are merely conceptual terms used to relatively identify components from each other, and thus they should not be interpreted as terms used to denote a particular order, priority or the like. The drawings for illustrating the present disclosure and its embodiments may be shown in somewhat exaggerated form in order to emphasize or highlight the technical contents of the present disclosure, but it should be understood that various modifications may be made by those skilled in the art in consideration of the above description and the illustrations of the drawings without departing from the scope of the present invention.

What is claimed is:

1. An actuator for a camera, comprising:
a reflector configured to reflect light of a subject to an image sensor installed in an inclined form and including a reflection surface with an inclination angle different from a slope of the image sensor;
a carrier on which the reflector is installed;
a driving unit configured to move the carrier forward and backward in the direction of the image sensor;
a housing configured to support the movement of the carrier;
a guiding rail provided to at least one of the housing and the carrier; and
a ball disposed on the guiding rail.

2. The actuator for a camera according to claim 1, wherein the guiding rail includes an inclined portion that tilts a posture of the carrier when the carrier moves.

3. The actuator for a camera according to claim 1, wherein the reflector is installed on the carrier so that when an angle of the image sensor relative to a horizontal plane is A°, an angle of the reflection surface is 0.5A° relative to the horizontal plane.

4. The actuator for a camera according to claim 2, wherein the guiding rail includes:
a first guiding rail having a shape extending in a direction in which the carrier moves; and
a second guiding rail having a shape extending in the direction in which the carrier moves and located closer to the image sensor than the first guiding rail.

5. The actuator for a camera according to claim 4, wherein the first guiding rail has a shape that becomes lowered in a direction toward the image sensor.

6. The actuator for a camera according to claim 4, wherein the second guiding rail has a shape that becomes raised in a direction toward the image sensor.

7. The actuator for a camera according to claim 5, wherein the second guiding rail has a shape that becomes raised in a direction toward the image sensor.

8. The actuator for a camera according to claim 1, further comprising:
an optical image stabilization (OIS) carrier on which a lens is mounted, the OIS carrier being configured to move in two directions orthogonal to each other based on a horizontal plane and being accommodated in the carrier,
wherein the reflector reflects the light of the subject passing through the lens to the image sensor.
